(19) United States
(12) Patent Application Publication
(10) Pub. No.: US 2003/0063061 A1
(43) Pub. Date: Apr. 3, 2003

(54) High contrast LCD microdisplay utilizing row select boostrap circuitry

(75) Inventors: Jerome A. Frazee, Milpitas, CA (US); Russell Flack, Scottsdale, AZ (US); Joseph T. Smith, Chandler, AZ (US)

Correspondence Address: INGRASSIA FISHER & LORENZ, P.C., 7150 E. CAMELBACK, STE. 325, SCOTTSDALE, AZ, 85251, US

(73) Assignee: Three-Five Systems, Tempe, AZ

(21) Appl. No.: 09/966,051

(22) Filed: Sep. 28, 2001

(51) Int. Cl. G09G 3/36

(52) U.S. Cl. 345/100

(57) ABSTRACT

A row driver circuit applies a boosted access voltage to a selected row of an LCD matrix so as to permit a higher video voltage to be stored on the pixel capacitor. The row driver circuit includes an input stage that operates at a first potential for receiving at least first and second control signals. The output of the input stage is coupled to a level shifting stage that operates at a second higher operating potential. The output of the level shifting stage is coupled to an output stage that generates a boosted access voltage having a potential that is higher than the operating potential of the level shifting stage.

### TECHNICAL FIELD

This invention relates generally to a liquid crystal (LCD), and more particularly to a high contrast LCD microdisplay utilizing charge-pump bootstrap circuitry to increase row-select line voltage.

### BACKGROUND OF THE INVENTION

For many decades, the cathode ray tube (CRT) was the dominant display device creating an image by scanning a beam of electrons across a phosphor-coated screen causing the phosphors to emit visible light. The beam is generated by an electron gun and is passed through a deflection system that causes the beam to rapidly scan left-to-right and top-to-bottom. A magnetic lens focuses the beam to create a small moving dot on the phosphor screen. This rapidly moving spot of light paints an image on the surface of the viewing screen.

Light emitting diodes (LEDs) have also found a multitude of uses in the field of optoelectronics. An LED is a solid-state device capable of converting a flow of electrons into light. By combining two types of semiconductive material, LEDs emit light when electricity is passed through them. Displays comprised of LEDs may be used to display a number of digits each having seven segments. Each segment consists of a group of LEDs, which in combination can form alphanumeric images. They are commonly used in, for example, digital watch displays, pager displays, cellular handset displays, etc., and due to their excellent brightness, LEDs are often used in outdoor signs. Generally speaking, however, they have been used primarily in connection with non-graphic, low-information-content alphanumeric displays. In addition, in a low-power CMOS digital system, the dissipation of LEDs or other comparable display technology can dominate the total system's power requirements, which could substantially negate the low-power dissipation advantage of CMOS technology.

Liquid crystal displays (LCDs) were developed in the 1970s in response to the inherent limitations in the then existing display technologies (e.g. CRTs, LED displays, etc.) such as excessive size, limited useful life, excessive power consumption, and limited information content. LCD displays comprise a matrix of pixels that are arranged in rows and columns that can be selectively energized to form letters or pictures in black and white or in a wide range of color combinations. An LCD modifies light that passes through it or is reflected from it as opposed to emitting light, as does an LED. An LCD generally comprises a layer of liquid crystalline material suspended between two glass plates or between a glass plate and a substrate. A principle advantage of an LCD over other display technologies is the ability to include thousands or even millions of pixels in a single display paving the way for much greater information content.

With the shift from segmented, very low information content displays to more information-rich digital products, LCDs now appear in products throughout the communications, office automation, and industrial, medical, and commercial electronics industries. Historically, the market for small displays has demanded low cost, minimal power consumption, and high image quality. To assure high quality, high contrast images, it is necessary that the voltage stored on the pixel capacitors match, as closely as possible, the original source video signal voltage. Unfortunately, the maximum video voltage that can be stored on each pixel capacitor is limited by the row line voltage, and therefore by increasing the row line voltage, each pixel capacitor may store a greater video voltage. Thus, it should be appreciated that it would desirable to provide a higher contrast, higher quality LCD microdisplay wherein the high voltage video image stored on the pixel capacitors closely matches the original source high voltage video signal. This is accomplished by providing row line drive circuitry that pumps the row line voltage to a higher level. Additional desirable features will become apparent to one skilled in the art from the foregoing background of the invention and the following detailed description of a preferred exemplary embodiment and appended claims.

### SUMMARY OF THE INVENTION

In accordance with the teachings of the present invention, there is provided a row driver circuit, which applies a boosted access voltage to a selected row of an LCD matrix so as to permit a higher video voltage to be stored on a pixel capacitor. The row driver circuit includes an input stage that operates at a first potential for receiving at least first and second control signals. The output of the input stage is coupled to a level shifting stage that operates at a second higher operating potential. The output of the level shifting stage is coupled to an output stage which generates a boosted access voltage having a potential that is higher than the operating potential of the level shifting stage.

### BRIEF DESCRIPTION OF THE DRAWINGS

The present invention will hereinafter be described in conjunction with the accompanying drawings wherein like reference numerals denote like elements, in which:

FIG. 1 is a schematic diagram of a single analog pixel cell;

FIG. 2 is a simplified functional diagram illustrating how pixel circuitry interacts with pixel mirrors and the remainder of an LCD microdisplay;

FIG. 3 is a simple cross-sectional view showing major components of an LCD microdisplay;

FIG. 4 is a partial schematic/partial block diagram of an N×M LCD microdisplay utilizing video switches in accordance with the present invention;

FIG. 5 is a simple block diagram illustrating the inventive row line select circuitry;

FIG. 6 is a schematic diagram of a first embodiment of the inventive row line select circuit;

FIG. 7 is a schematic diagram of a second embodiment of the inventive row line select circuit;

FIG. 8 is a timing diagram useful in explaining the operation of the circuit shown in FIG. 6; and

FIG. 9 is a timing diagram useful in explaining the operation of the circuit shown in FIG. 7.

### DESCRIPTION OF THE PREFERRED EXEMPLARY EMBODIMENT

The following detailed description of a preferred embodiment is mainly exemplary in nature and is not intended to limit the invention or the application or use of the invention.

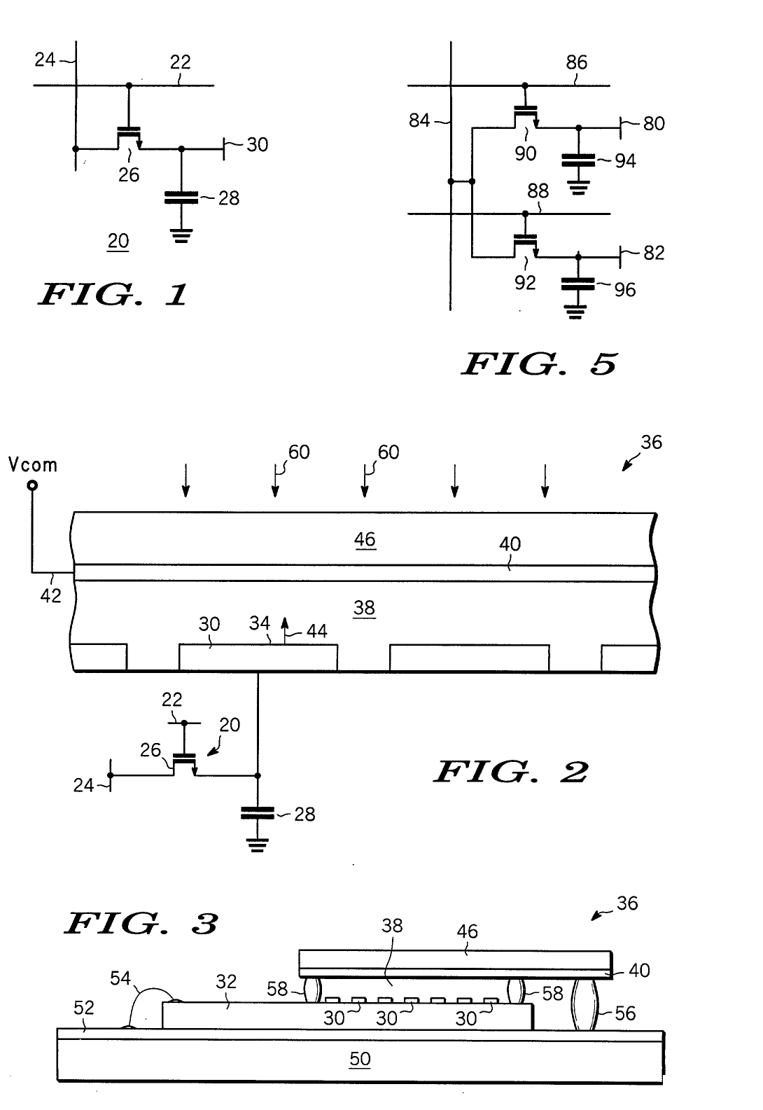

FIG. 1 is a schematic diagram of an individual pixel 20 coupled to a row line 22 and a column line 24. Of course it should be understood, that an actual LCD display would include a large matrix of row lines 22, column lines 24, and pixels 20. Each pixel includes an access n-channel field-effect-transistor 26, which has a gate coupled to row line 22 and a drain coupled to column line 24. The source of access transistor 26 is coupled to a first terminal of pixel capacitor 28 and to pixel mirror 30, the function of which will be described more fully in connection with FIG. 2. The other terminal of capacitor 28 is coupled to a source of potential; e.g. ground.

FIG. 2 is a simplified functional diagram illustrating how each pixel 20 interacts with an associated mirror 30 to create a liquid crystal image. FIG. 3 is a simplified cross-sectional view of a liquid crystal display that likewise will be useful in explaining the operation of a liquid crystal display. In both cases, like reference numerals denote like elements. Referring to both FIG. 1 and FIG. 2, pixel 20, described in connection with FIG. 1, is again shown coupled to mirror 30, a plurality of which reside on the surface of a semiconductor substrate (e.g. silicon) 32 as is shown in FIG. 3. Mirrors 30 may be metallic (e.g. aluminum) and have a thickness of, for example, 2000 angstroms, and each has a reflective surface 34 which may or may not have enhanced reflective properties. When row line 22 is selected, transistor 26 becomes conductive, thus permitting the video signal (e.g. a digital video signal) appearing on column line 24 to charge pixel capacitor 28. Thus, the voltage on mirror 34 will vary in accordance with the voltage across pixel capacitor 28. Located within region 38 is a liquid crystal material, the molecules of which orient themselves in a relationship that depends on the voltage applied thereacross. A glass seal 46 is provided under which a layer of indium-tin-oxide (ITO) 40 is provided which is a transparent conductive material to which a potential V_{com} is applied as is shown at 42. V_{com} may, for example, be approximately 7 volts. The voltage stored across pixel capacitor 28 and therefore the voltage on mirror 34 may approach a much higher voltage (e.g. 17-18 volts) thus placing a significant potential difference between mirror 34 and ITO layer 40 and causing the molecules of the liquid crystal material in region 38 to assume a first orientation corresponding to black. Alternatively, if the voltage stored across pixel capacitor 28 is low, thus reducing the potential difference between mirror 30 and ITO layer 40, the molecules of the liquid crystal material in region 38 will assume a different orientation (e.g. corresponding to white). That is, a high voltage on mirror 30 may cause the molecules of the liquid crystal material to substantially prevent light (indicated by arrow) 44 from being reflected from mirror surface 34 while a lower voltage on mirror 30 will permit light 44 to be reflected.

Mirrors 30 reside on the surface of a semiconductor substrate (e.g. silicon) 32, which has deposited therein or formed thereon all the active regions (e.g. pixel capacitors, access transistors, etc.) required to produce a working device. Semiconductor die is supported by a substrate 50 (e.g. ceramic) which may have a flexible printed circuit board 52 disposed thereon for the purpose of making external connection to semiconductor die 32 and ITO layer 40 by, for example, wire bond 54 and conductive epoxy crossover 56. Finally, a perimeter seal 58 is provided between the surface of semiconductor dye 32 and the surface of ITO layer 40 to seal the liquid crystal material within region 38.

In operation, ambient or generated light (indicated by arrows 60) impinges upon and passes through transparent glass layer 46 and ITO layer 40. If the potential difference between mirror 30 and ITO layer 42 is high, virtually no light will be reflected from surface 34 of mirror 30 and therefore that portion of the video image created by pixel 20 will approach black. If, on the other hand, the potential difference between mirror 30 and ITO layer 42 is very low, virtually all of the light 60 striking surface 34 will be reflected and that portion of the video image to be created by pixel 20 will approach white. It should be clear that between these two extremes, there are a multiple of shades extending from white to black, which may be displayed depending on the video voltage stored on pixel capacitor 28 and applied to mirror 30. Since the operation and structure of liquid crystal displays is well known and well documented in technical literature. For example, see U.S. Pat. No. 3,862,360 entitled “Liquid Crystal Display System With Integrated Signal Display Storage Circuitry” issued Jan. 21, 1975 and assigned to Hughes Aircraft Company, the teachings of which are hereby incorporated by reference.

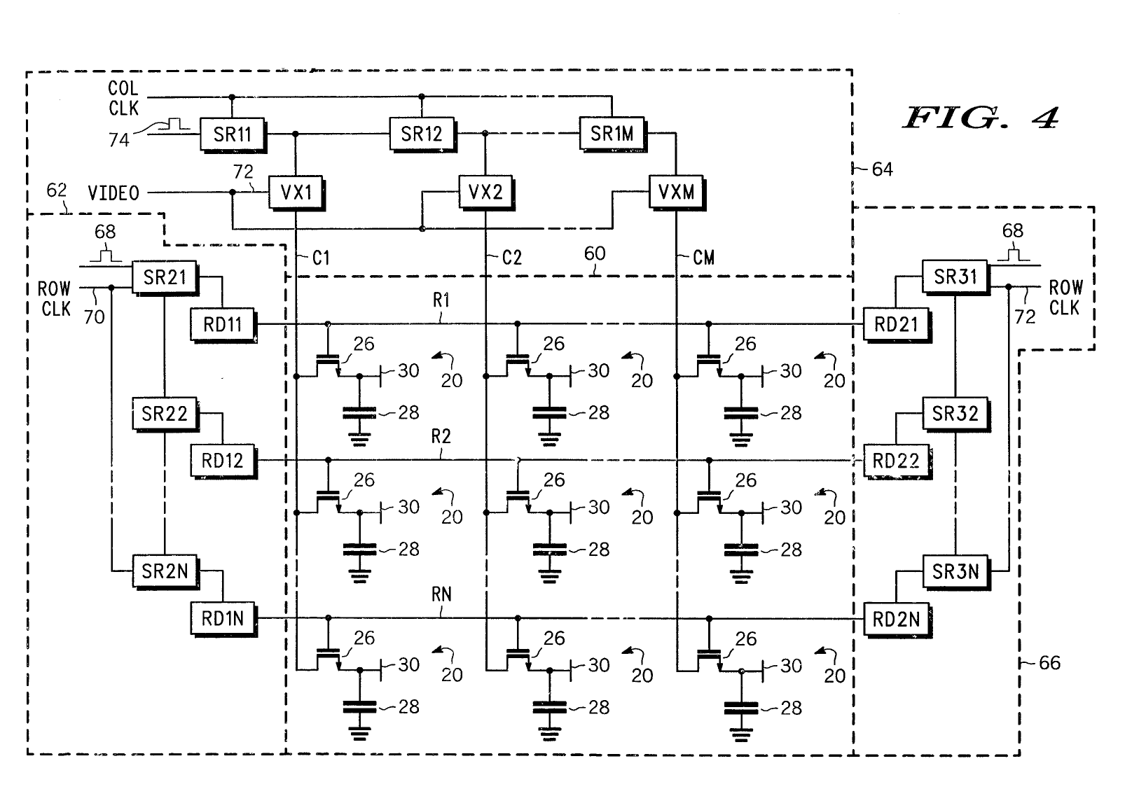

FIG. 4 is a partial schematic/partial block diagram of an N×M LCD display utilizing video switches in accordance with the teachings of the present invention. As can be seen, the apparatus of FIG. 4 comprises an N×M matrix 60 of video pixels 20 (only several of which are shown for clarity), a plurality of rows R1, R2, . . . , RN, and a plurality of columns C1, C2, . . . , CM. The apparatus also includes a first row select circuit 62, a first column select circuit 64 and optionally a second row select circuit 66. Row select circuit 62 includes a shift register containing bits SR21, SR22, . . . , SR2N, the output of each of which is respectively coupled to a plurality of row drivers RD11, RD12, . . . RD1N. Similarly, column select circuit 64 includes a serial shift register comprised of bits SR11, SR12, . . . , SR1M each having outputs coupled respectively to video switches VX1, VX2, . . . , VXN.

As is well known in the art, the pixels coupled to the columns and rows are scanned in order to create an LCD image. The following is one example of how this scanning process is accomplished. Starting with row select circuitry 62, shift register bit SR21 has a signal 68 applied to an input thereof. Under the control of a row clock applied to the clock input 70 of bit SR21 and to the clock inputs of each successive stage SR22, . . . , SR2N, signal 68 is propagated through the shift register. The output of each shift register bit is coupled to a corresponding row driver RD11, RD12,. . . , RD1N each of which is sequentially energized as signal 68 propagates through the bits of the shift register. This process in turn sequentially selects rows R1, R2, . . . , RN.

Column select circuit 64 likewise comprises a shift register comprised of shift register bits SR11, SR12, . . . , SR1M each of which has an output coupled respectively to a plurality of column video switches VX1, VX2, . . . , VXM. The output of each video switch VX1, VX2, . . . , VXM is coupled respectively to columns C1, C2, . . . , CM. Each video switch also has an input for receiving the video signal to be displayed as is shown at 72. A pulse signal 74 is applied to the input of the first shift register bit SR11, and through the action of a column clock which is applied to the clock inputs of each of the shift register bits SR11, SR12, . . . , SR1M, pulse 74 is serially clocked through successive bits of the shift register. Thus, each of the video switches VX1, VX2, . . . , VXM each has an input which is respectively coupled to a corresponding output of a shift register bit for sequentially applying the video signal appearing at 72 to each of the column lines C1, C2, . . . , CM.

If desired, a second row select circuit 66 may be provided to drive the row lines at their opposite ends in order to provide a greater drive capacity. Circuit 66 includes a shift register comprised of stages SR31, SR31, . . . , SR3M and a plurality of row drivers RD21, RD22, . . . , RD2N. SR31 receives the same input signal 68 and row clock at 72 so as to operate synchronously with row select circuit 62. Thus, instead of driving the matrix rows from only one end and propagating the drive signal down the entire row, each row is driven at both ends to improve performance.

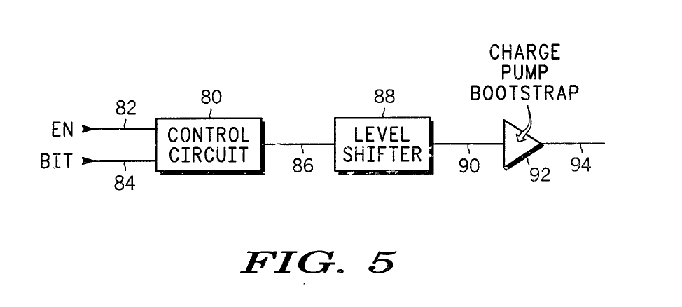

FIG. 5 is a simplified block diagram of the inventive row select driver circuit. Control circuit 80 receives a plurality of input controls signals; for example, an enable signal (EN) at input 82 and a bit signal (BIT) at input 84. It should be clear that other types of control signals can be applied to the circuit as will be more fully described hereinbelow. Control circuit 80 generally comprises CMOS technology wherein a LOW represents a voltage of approximately zero volts (i.e. ground) and a HIGH represents a voltage of approximately 3.3 volts. The output 86 of control circuit 80 is applied to a level shifter 88 that operates at a substantially higher voltage (e.g. 18 volts) to translate control signals to a higher potential. Finally, the output of level shifter 88 shown as 90 is applied to charge pump bootstrap circuitry 92 that has an output coupled to the selected row line 94.

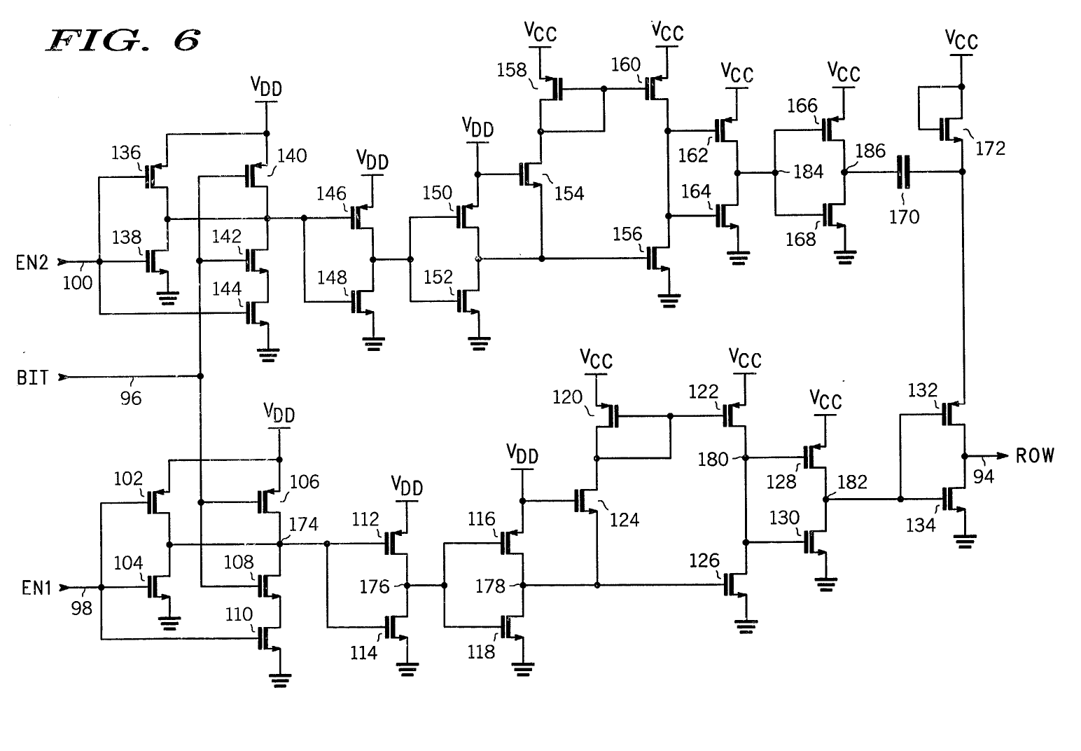

FIG. 6 is a schematic diagram of a first exemplary embodiment of the inventive row line select circuit shown in FIG. 5. As can be seen, the low voltage signals controlling this circuit are a bit signal (BIT) shown at 96, a first enable signal (EN1) shown at 98 and a second enable signal (EN2) shown at 100. The output of the circuit is coupled to row line (ROW) 94. These control signals are shown in the timing diagram of FIG. 8.

The lower portion of the circuit includes a first inverter circuit comprised of p-channel field-effect-transistor 102 and n-channel field-effect-transistor 104 each have their gates coupled to receive enable signal EN1. The source of transistor 102 is coupled to receive a source of supply voltage VDD (e.g. 3.3 volts). The drain of transistor 104 is coupled to the drain of transistor 102 and the source of transistor 104 is coupled to receive a second potential (e.g. ground). P-channel field-effect-transistor 106 and n-channel field-effect-transistor 108 have a common drain, and each have their gate coupled to receive control signal (BIT). The source of transistor 106 is coupled to receive VDD, and the source of transistor 108 is coupled to the drain of n-channel field-effect-transistor 110, which has a gate coupled to receive EN1 and a source coupled to ground.

A second inverter is comprised of p-channel field effect transistor 112 having a source coupled to VDD and an n-channel field-effect-transistor 114 having a source coupled to ground. Transistors 112 and 114 have a common drain, and their gates are coupled in common to the common drain of transistors 106 and 108. A third inverter is comprised of p-channel field-effect-transistor 116 having a source coupled to VDD and an n-channel field-effect-transistor 118 having a source coupled to ground. The drains of transistors 116 and 118 are coupled together and to the common drain of transistors 112 and 114.

A first current mirror circuit is provided and is comprised of p-channel field-effect-transistors 120 and 122 and n-channel field-effect-transistors 124 and 126. As can be seen, transistor 120 is diode coupled and has a gate coupled to the gate of transistor 122. The sources of transistors 120 and 122 are coupled to receive a higher voltage VCC (e.g. 18 volts). The drain of transistor 120 is coupled to the drain of transistor 124 which has a gate coupled to the source of transistor 116. Transistor 124 has a source coupled to the gate of transistor 126, to the common drain of transistor 116 and 118. Transistors 122 and 126 have a common drain forming the output of the level shifting current mirror circuit, and transistor 126 has a source coupled to ground.

A fourth inverter is comprised of p-channel field-effect-transistor 128 and n-channel field-effect-transistor 130 each having a common drain and each having a gate coupled to the common drain of transistors 122 and 126 (i.e. the output of the current mirror level shifting circuit). The source of transistor 128 is coupled to receive VCC, and the source of transistor 130 is coupled to receive ground. The output of this inverter (i.e. the common drains of transistors 128 and 130) are coupled to the gates of p-channel field-effect-transistor 132 and n-channel field-effect-transistor 134 which has a source for coupling to ground. Transistors 132 and 134 have a common drain that is coupled to the selected row line 94.

The upper portion of the circuit is very similar to the upper portion discussed above. A first inverter is comprised of p-channel field-effect-transistor 136 and n-channel field-effect-transistor 138 each having a gate coupled to a second enable signal (EN2). Intermediate circuitry comprised of p-channel field-effect-transistor 140 and n-channel field-effect-transistors 142 and 144 has an output that is coupled to the gates of a second inverter comprised of p-channel field-effect-transistor 146 and n-channel field-effect-transistor 148. The output of this inverter is coupled to the input of a third inverter comprised of p-channel field-effect-transistor 150 and n-channel field-effect-transistor 152. The output of this third inverter (i.e. the common drain of transistors 150 and 152 are coupled respectively to the source of n-channel field-effect-transistor 154 and the gate of n-channel field-effect-transistor 156 which, in combination with p-channel field-effect-transistors 158 and 160, form a level shifting current mirror circuit as was previously described. The common drains of transistors 156 and 160 (i.e. the output of the current mirror level shifting circuit) are coupled to a fourth inverter comprised of p-channel field-effect-transistor 162 and n-channel field-effect-transistor 164. The output of this fourth transistor is coupled to the input of a fifth inverter comprised of p-channel field-effect-transistor 166 and n-channel field-effect-transistor 168.

The output of the fifth inverter (i.e. the common drains of transistors 166 and 168) is coupled to a first terminal of a capacitor 170. The second terminal of capacitor 170 is coupled to diode coupled NPN transistor 172 and to the source of transistor 132.

The operation of the circuit shown in FIG. 6 will now be described in connection with FIG. 8. At time T1, both BIT and EN1 go HIGH, as is shown in FIG. 8. Thus the voltage at node 174 goes LOW. This is applied to the input of the inverter formed by transistors 112 and 114 causing a HIGH to appear at node 176 which is applied to the input of the next inverter stage (transistors 116 and 118) causing a LOW to appear at node 178. The LOW at node 178 causes transistor 126 to remain off, resulting in the voltage at node 180 to go high (i.e. approaching 18 volts). This voltage is applied to the input of the next inverting stage comprised of transistors 128 and 130 producing a LOW at node 182 which turns transistor 134 off and transistor 132 on. Thus, the voltage at the row line will rise as a result of current flowing from VCC through diode-coupled transistor 172. This rise in voltage at the row line is depicted in FIG. 8 between time T₁ and T₂. If VCC is, for example, 18 volts and assuming a voltage drop across transistor 172 of approximately 5.5 volts, the row voltage reaches a level of approximately 12.5 volts.

During the time interval T1-T2, enable signal EN2 was in a low state. Since the upper portion of the circuit is substantially identical to the lower portion of the circuit, the upper portion of the circuit operates in the same manner to produce a high voltage at node 184 which turns transistor 168 on pulling node 186 to ground. Thus, during this period of time, capacitor 170 (e.g. 5 pf) begins to charge. When EN2 goes high, as is shown at T2 in FIG. 8, a LOW is produced at node 184 causing transistor 168 to turn off and transistor 166 to turn on. Thus, capacitor 170 discharges through transistor 132 which is still on boosting the voltage on the row line 94 by the amount of voltage stored across capacitor 170 as is shown commencing at time T₂ in FIG. 8.

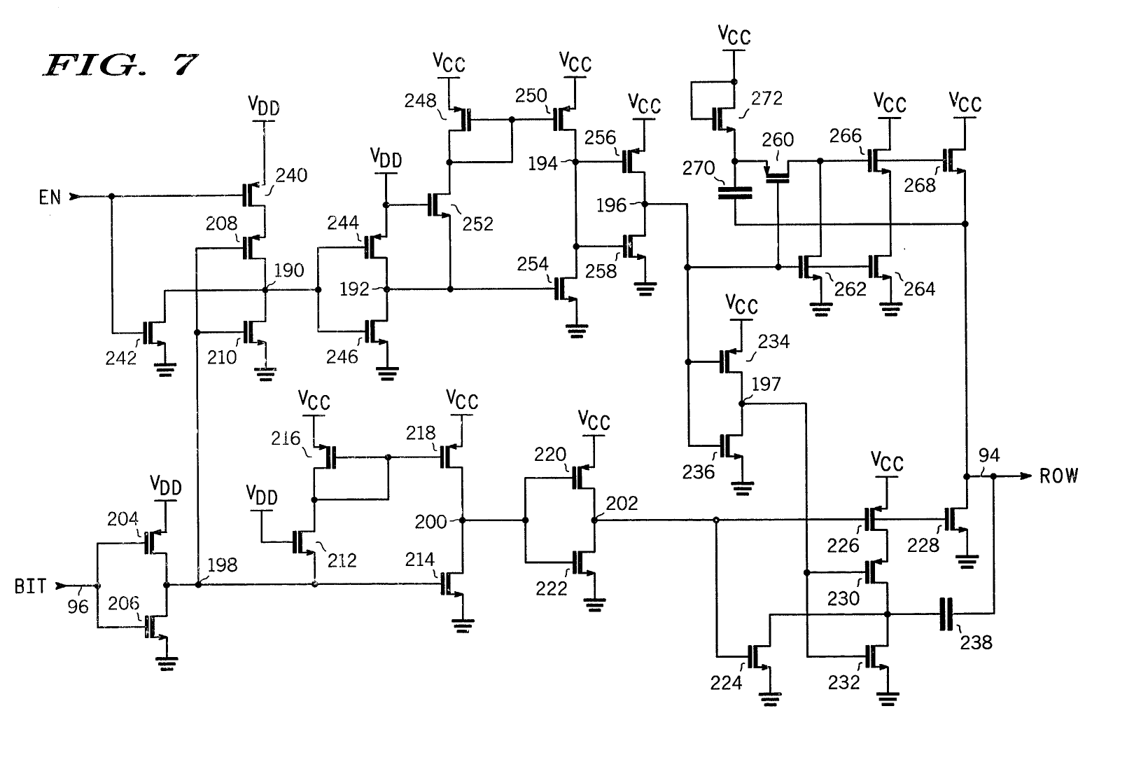

FIG. 7 is a schematic diagram of a second exemplary embodiment of the present invention. In this case, however, only a single enable signal (EN) is utilized in addition to the BIT signal. BIT is applied to the input of a first inverter comprised of p-channel field-effect-transistor 204 and n-channel field-effect-transistor 206. The source of transistor 204 is coupled to receive VDD, and the source of transistor 206 is coupled to ground. Transistors 204 and 206 have a common drain coupled to node 198, to the gates of p-channel field-effect-transistor 208 and n-channel field-effect-transistor 210 respectively, to the source of n-channel field-effect-transistor 212, and to the gate of n-channel field-effect-transistor 214.

Transistors 212, 214, and p-channel field-effect-transistor 216 and 218 are coupled in a current mirror configuration. That is, transistor 216 has a drain coupled to the drain of transistor 212, a source coupled to receive VCC, and a gate coupled to the gate transistor 218. Transistor 218 has a source coupled to receive VCC, and a drain coupled to node 200 and to the drain of transistor 214. The source of transistor 214 is coupled to ground. The output of this level shifting current mirror (node 200) is coupled to the input of an inverter comprised of p-channel field-effect-transistor 220 and n-channel field-effect-transistor 222. Transistors 220 and 222 are coupled in series between VCC and ground and have a common drain coupled to node 202.

Node 202 is coupled to the gate of n-channel field-effect-transistor 224 to the gate of p-channel field-effect-transistor 226, and to the gate of n-channel field-effect-transistor 228. The source of transistor 226 is coupled to receive VCC, and its drain is coupled to the source of p-channel field-effect-transistor 230. The drain of transistor 230 is coupled to the drain of transistor 224 and to the drain of n-channel field-effect-transistor 232. Transistor 232 has a gate coupled to the gate of transistor 230 and to the output of an inverter comprised of p-channel field-effect-transistor 234 and n-channel field-effect-transistor 236. The sources of both transistors 224 and 232 are coupled to receive a potential (e.g. ground). The common drain of transistors 230 and 232 are coupled to a first plate of capacitor 238 (e.g. 2.5 pf) which has a second plate coupled to row line 94. The enable signal (EN) 97 is coupled to the gates of p-channel field-effect-transistor 240 and n-channel field-effect-transistor 242. Transistor 242 has a source for coupling to ground and a drain coupled to the common drain of transistors 208 and 210 (node 190).

Node 190 is coupled to the input of an inverter comprised of p-channel field-effect-transistor 244 and n-channel field-effect-transistor 246. The source of transistor 244 is coupled to receive VDD, and the source of transistor 246 is coupled to receive a potential (e.g. ground). A second current mirror circuit is comprised of p-channel field-effect-transistors 248 and 250 and n-channel field-effect-transistors 252 and 254. Node 192 is coupled to the gate of transistor 254 and to the source of transistor 252, which in turn has a gate for coupling to VDD. Transistor 254 has a source for coupling to ground and a drain coupled to the drain of transistor 250 forming the output of the level shifter current mirror circuit at node 194. As can be seen, transistor 248 is diode coupled, and the sources of both transistors 248 and 250 are coupled to receive a potential VCC.

Node 194 is coupled to the gates of p-channel field-effect-transistor 256 and n-channel field-effect-transistor 258 which are coupled in series between VCC and ground. The common drains of transistor 256 and 258 form this inverters output (node 196). Node 196 is coupled to the gates of transistors 234 and 236, and to the gates of p-channel field-effect-transistor 260 and n-channel field-effect-transistors 262 and 264. Transistor 262 has a drain coupled to the drain of transistor 260 and to the gates of n-channel field-effect-transistors 266 and 268, each of which has a drain coupled to receive VCC. Transistor 266 has a source coupled to the drain of transistor 264 and to a first plate of capacitor 270. The second plate of capacitor 270 is coupled to the source of transistor 260 and to the source of diode coupled n-channel field-effect-transistor 272. The source of transistor 268 is coupled to row line 94.

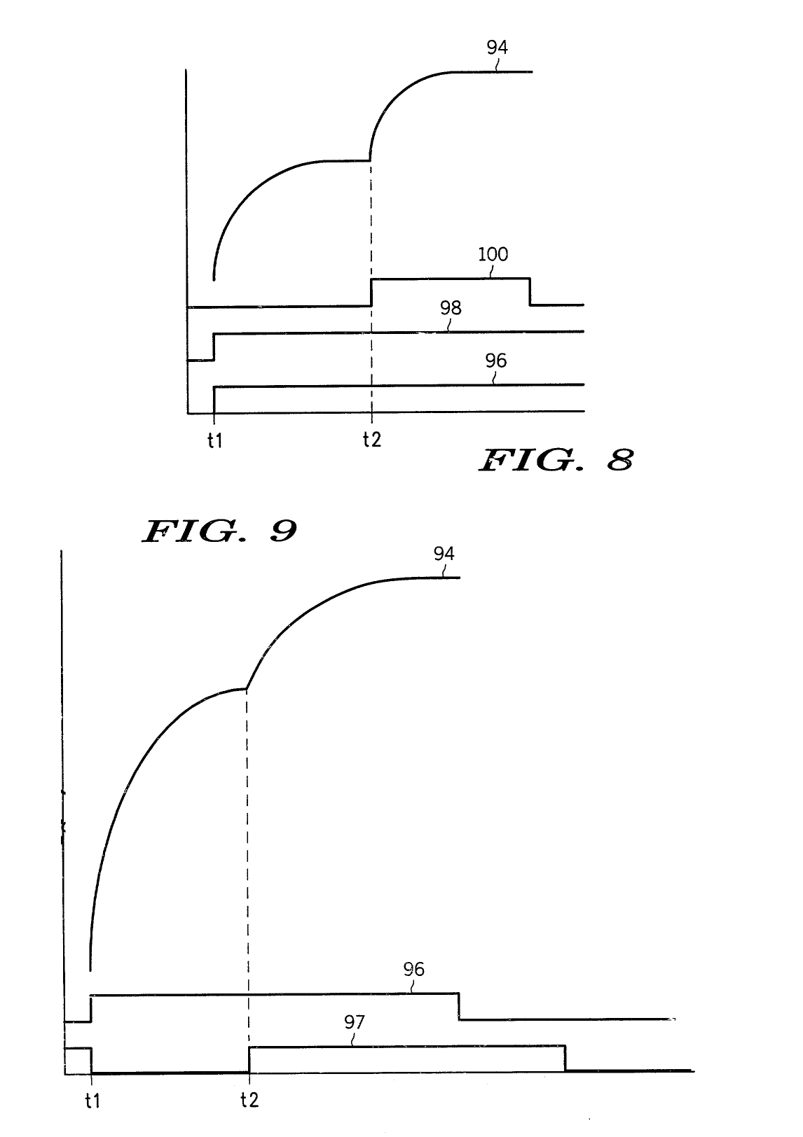

The operation of the circuit shown in FIG. 7 will now be described with the help of the timing diagram shown in FIG. 9. Let us assume that between the time internal T1-T2, BIT is HIGH and the enable (EN) is LOW. With BIT applied to the gate electrodes of transistors 204 and 206, node 198 goes low turning transistor 214 off. The current mirror action of transistors 212, 216 and 218 causes node 200 to go HIGH. This state is inverted by inverter coupled transistors 220 and 222 to create a LOW voltage at node 202 turning transistor 226 on and transistor 224 and 228 off. The LOW at node 198 is applied to an inverter comprised of transistors 190 and 210 causing a HIGH voltage to appear at node 190. The signal at node 190 is again inverted through the action of transistors 244 and 246 to produce a LOW voltage at node 192, which is applied to the gate of transistor 254 turning it off. Again, the current mirror action of transistors 252, 248 and 250 create a HIGH voltage at node 194, which is inverted to create a LOW voltage at node 196. This voltage is inverted through the action of inverter coupled transistors 234 and 236 to create a HIGH voltage at node 197 turning transistors 230 off and 232 on. Thus, capacitor 238 has a path to ground via transistor 232 and begins to charge.

The LOW voltage at node 196 turns transistors 262 and 264 off and transistor 260 on. Capacitor 270 which has previously been charged in a manner to be described below then discharges through transistor 268, boosting it's gate voltage compensating for the body drop voltage across transistor 268 when it turns on. Thus, node 94 (i.e. the row line) can rise to a voltage level substantially equal to VCC (e.g. 18 volts) as is shown in FIG. 9 during time internal T1-T2.

When the enable signal EN goes HIGH at time T2, the voltage at node 197 falls to a LOW causing transistor 232 to turn off and transistor 230 to turn on. Since BIT is still high, transistor 224 is likewise off and transistor 226 is on. Thus, the charge stored on capacitor 238 now discharges to row line 94 boosting its voltage once more as is shown commencing at time T2 in FIG. 9. Since node 196 is high, transistor 260 is turned off and transistor 264 is turned on. Thus, capacitor 270 now has a pass-to-ground through transistor 264 and begins charging for the next cycle. The row line is disabled (i.e. turned off) when BIT 96 goes LOW and the voltage at node 202 is HIGH which turns on transistor 228 pulling the row line 94 to ground.

From the foregoing description, it should be appreciated that a CMOS row driver circuit and a liquid crystal display incorporating same has been provided which boosts the pixel row select line voltage which is applied to the gate of each pixels access transistor permitting a significantly higher video voltage to be stored on the pixel capacitors. This in turn enhances the contrast of the image displayed on the LCD.

While preferred exemplary embodiments have been presented in the foregoing detailed description, it should be appreciated that a vast number of variations in the embodiments exist. It should also be appreciated that these preferred embodiments are only an example and are not intended to limit the scope, applicability of configuration of the invention in any way. Rather, the foregoing detailed description provides those skilled in the art with a convenient roadmap for implementing the preferred exemplary embodiments of the invention. Various changes may be made in the function and arrangement described above without departing from the spirit and scope of the invention as set forth in the appended claims.

1. A row driver circuit for receiving a plurality of control signals and for applying in response thereto an access voltage to a selected row of an LCD matrix, comprising:
an input stage having a first operating potential for receiving at least first and second control signals;
a level shifting stage having an input coupled to said input stage and having a second higher operating potential; and
an output stage having an input coupled to said level shifting stage for generating said access voltage at a potential higher than said second operating potential.

2. A row driver circuit according to claim 1 wherein said output stage comprises:
a first output circuit responsive to said plurality of control signals for raising said access voltage to a first voltage level; and
a second output circuit responsive to said plurality of control signals for increasing said access voltage from said first level to a second level.

3. A row driver circuit according to claim 2 wherein said second level is greater than said second operating potential.

4. A row driver circuit according to claim 2 wherein said first output circuit includes a first charge pump.

5. A row driver circuit according to claim 4 wherein said second output circuit includes a second charge pump.

6. A row driver circuit according to claim 4 wherein said level shifting stage comprises:
a first level shifter coupled between said input stage and said first output circuit; and
a second level shifter coupled between said input stage and said second output circuit.

7. A row driver circuit according to claim 6 wherein said first level shifter includes a first current mirror.

8. A row driver circuit according to claim 7 wherein said second level shifter includes a second current mirror.

9. A row driver circuit according to claim 8 wherein said input stage comprises:
a first input circuit for receiving at least a first one of said plurality of control signals and having an output coupled to said first level shifter; and
a second input circuit for receiving a second one of said plurality of control signals and having an output coupled to said second level shifter.

10. A row driver circuit according to claim 9 wherein said first operating potential is approximately 3.3 volts.

11. A row driver circuit according to claim 10 wherein said second operating potential is approximately 18 volts.

12. A row driver circuit according to claim 11 wherein said first level is approximately 12.5 volts.

13. A row driver circuit according to claim 12 wherein said second level is approximately 22 volts.

14. An LCD display for generating an image of a video signal, said LCD display being of the type which includes a matrix of pixels arranged in a plurality of rows and a plurality of columns which are selectively energized to create said image, comprising:
a first column select circuit for energizing each of said columns in accordance with the first predetermined sequence; and
a row select circuit for providing a boosted access voltage to each of said rows in accordance with a second predetermined sequence, said row select circuit including a plurality of row driver circuits, each row driver circuit comprising:
an input stage having a first operating potential for receiving at least first and second control signals;
a level shifting stage having an input coupled to said input stage and having a second higher operating potential; and
an output stage having an input coupled to said level shifting stage for generating said access voltage at a potential higher than said second operating potential.

15. An LCD display according to claim 14 wherein said output stage comprises:
a first output circuit responsive to said plurality of control signals for raising said access voltage to a first voltage level; and
a second output circuit responsive to said plurality of control signals for increasing said access voltage from said first level to a second level.

16. An LCD display according to claim 15 wherein said second level is greater than said second operating potential.

17. An LCD display according to claim 15 wherein said first output circuit includes a first charge pump.

18. An LCD display according to claim 17 wherein said second output circuit includes a second charge pump.

19. An LCD display according to claim 17 wherein said level shifting stage comprises:
a first level shifter coupled between said input stage and said first output circuit; and
a second level shifter coupled between said input stage and said second output circuit.

20. An LCD display according to claim 19 wherein said first level shifter includes a first current mirror.

21. An LCD display according to claim 20 wherein said second level shifter includes a second current mirror.

22. An LCD display according to claim 21 wherein said input stage comprises:
a first input circuit for receiving at least a first one of said plurality of control signals and having an output coupled to said first level shifter; and
a second input circuit for receiving a second one of said plurality of control signals and having an output coupled to said second level shifter.

23. An LCD display according to claim 22 wherein said first operating potential is approximately 3.3 volts.

24. An LCD display according to claim 23 wherein said second operating potential is approximately 18 volts.

25. An LCD display according to claim 24 wherein said first level is approximately 18 volts. 26. An LCD display according to claim 25 wherein said second level is approximately 22 volts.
